(19) United States
(12) Patent Application Publication
(10) Pub. No.: US 2024/0353807 A1
(43) Pub. Date: Oct. 24, 2024

(54) GRID EDGE INTELLIGENCE

(71) Applicant: X Development LLC, Mountain View, CA (US)

(72) Inventors: Sze Mei Cat Wong, Johns Creek, GA (US); Leo Francis Casey, San Francisco, CA (US); Sushant Kumar, San Jose, CA (US)

(21) Appl. No.: 18/302,449

(22) Filed: Apr. 18, 2023

(51) Int. Cl. G05B 19/042

(52) U.S. Cl. CPC G05B 19/042; G05B 2219/2639

(57) ABSTRACT

This disclosure describes a system and method for a central controller layer to monitor conditions and control operations of an electric grid. The central controller layer communicates with an intermediate controller layer that includes hubs to monitor operations of grid edge devices connected to different regions of the electric grid. The central controller layer obtains, from each hub, sensor data corresponding to measurements performed by the grid edge devices. The central controller layer determines, based on the sensor data and expected grid-wide operations, control strategies with expected electrical operating conditions for the respective region, and provides a respective control strategy to each hub. In response to receiving the respective control strategy for the hub, each hub generates operational parameters for at least one grid edge device that cause a grid edge device to adjust its operation based on the expected amount of power flow for the hub.

### BACKGROUND

This disclosure generally relates to grid edge devices.

Grid edge devices (e.g., inverters, batteries, and solar panels) are limited by sensor insights at the grid edge, without consideration from higher-level grid operations and events. Many grid devices simply perform limited, localized actions (e.g., activating a switch to configure the circuit) in response to disturbances and other kinds of grid events. Such events (e.g., disturbances, shifting weather patterns, feeder outages, maintenance) can affect one portion of the electric grid and introduce significant constraints on other portions of the electric grid, regardless of proximity to the affected portion. As grid edge devices become prominent points of delivery, e.g., providing electricity for customers, there is an increasing need for intelligent operation, planning, and integration of the grid edge devices on the electric grid.

### SUMMARY

This specification describes techniques that involve a system, and operations for an electric grid operation system that includes a central controller layer configured to monitor conditions of an electric grid and control operations of the electric grid. The electric grid operation system also includes an intermediate controller layer in communication with the central controller layer, where the intermediate controller layer includes a plurality of hubs configured to monitor operations of grid edge devices connected to different regions of an electric grid. The central controller layer of the electric grid operation system is configured to perform operations that include obtaining, from each hub, sensor data corresponding to measurements performed by the grid edge devices monitored by the hub, and determining, based on the sensor data and expected grid-wide operations, individual control strategies for each different region of the electric grid. Each control strategy includes expected electrical operating conditions for the respective region of the electric grid over a period of time.

The operations performed by the central controller layer of the electric grid operation system also include providing a respective control strategy to each hub. Each hub of the plurality of hubs in the intermediate controller layer is configured to perform operations including, in response to receiving the respective control strategy for the hub, generating one or more operational parameters for at least one grid edge device for the operation of the electric grid. The generation of the one or more operational parameters is based on the expected amount of power flow for the hub. The operations of each hub of the plurality of hubs in the intermediate controller layer also include providing the one or more operational parameters to the at least one grid edge device, where providing the one or more operational parameters causes the at least one grid edge device to adjust its operation.

In general, this disclosure relates to an electric grid operation system that includes a central controller layer for central operation and monitoring of an electric grid, and an intermediate controller layer made up of multiple hubs configured to adjust local operation of grid edge devices. Each hub of the intermediate controller layer is configured to monitor a respective region of the electric grid, including the grid edge devices of the respective region. A central controller layer of the electric grid operation system can obtain data regarding operations of grid edge devices at the grid edge, as well as other data sources such as weather, market, distribution, and transmission data regarding the electric grid, including neighboring electric grids coupled to or in communication with the electric grid. The central controller layer performs data analytics on the data sources and regional grid data from the hubs to determine control strategies for the hubs. The hubs can determine operational parameters for the grid edge devices, in which the grid edge devices can perform control functions to meet the operational parameters.

Particular embodiments of the subject matter described in this specification can be implemented to realize one or more of the following technical advantages. As described in this specification, grid edge devices can be configured to operate using holistic control strategies to provide improved resiliency and efficiency for electric grids. The central controller layer of the electric grid operation system generates forecasts for electrical loads and power flows using data analytics, predictive modeling, and algorithms that enable improved performance for capabilities of an electric grid. The improved accuracy and data fidelity occurs from including localized data from grid edge devices, improving the control of the grid edge devices and can achieve more efficient performance in battery charging and discharging patterns, volt-VAR optimization, power quality improvement, load shedding/recovery prioritization, and so on.

In some implementations, the data analytics performed by the central controller layer can enable additional capabilities for an electric grid such as predictive asset management, predictive outage management, and distribution automation. These capabilities can be added to an existing electric grid using the central controller layer, as the holistic control strategies from the central controller layer enable coordinated autonomous operation of the grid edge devices. The coordinated autonomous operation of the grid edge devices can responsively update the central controller layer (e.g., by the hubs in the intermediate controller layer monitoring the grid edge devices), thereby providing an accurate, up-to-date assessment of local grid operation.

Further still, the techniques described in this specification provide technical advantages in protocol agnosticism and conversion. The central controller layer enables autonomous intelligent control of the grid edge devices coordinated across the regions of the electric grid through the holistic control strategies, based on data analytics performed across multiple data sources and data from the hubs monitoring regions of the grid edge devices. Compared to some methods for controlling local devices at the grid edge, determining and providing control strategies relies on the grid edge devices being able to autonomously operate and meet operational parameters, e.g., without providing direct control inputs from the central controller layer or intermediate controller layer. By leveraging the data transmissibility between layers of the electric grid operation system, the central controller layer can consolidate existing message protocols between components of the electric grid to a publisher/subscriber protocol for efficient message transmission between layers of an electric grid.

Furthermore, the central controller layer also provides improved data quality assessment, as the central controller layer can analyze data and compare from different resources to detect anomalies. For example, the central controller layer can identify discrepancies in data provided at one layer or data source of the electric grid operation system from other layers or data sources of the electric grid operation system. The abnormal data can be excluded for the purposes of generating control strategies by the central controller layer, thereby improving the accuracy of the demand forecasts for the hubs and grid edge devices.

These and other embodiments can each optionally include one or more of the following features.

In an aspect, an electric grid operation system includes a central controller layer configured to monitor conditions of an electric grid and control operations of the electric grid and an intermediate controller layer in communication with the central controller layer, wherein the intermediate controller layer comprises a plurality of hubs configured to monitor operations of grid edge devices connected to different regions of the electric grid. The central controller layer is configured to perform operations that include obtaining, from each hub, sensor data corresponding to measurements performed by the grid edge devices monitored by the hub. The operations also include determining, based on the sensor data and expected grid-wide operations, individual control strategies for each different region of the electric grid, wherein each control strategy includes expected electrical operating conditions for the respective region of the electric grid over a period of time. The operations also include providing a respective control strategy to each hub. Each hub of the plurality of hubs in the intermediate controller layer is configured to perform operations that include, in response to receiving the respective control strategy for the hub, generating one or more operational parameters for at least one grid edge device for the operation of the electric grid. Generating the one or more operational parameters is based on the expected amount of power flow for the hub. The operations also include providing the one or more operational parameters to the least one grid edge device, wherein providing the one or more operational parameters causes the at least one grid edge device to adjust its operation.

In some implementations, the electric grid operation system includes the expected electrical operating conditions of the control strategy for the region include at least one of (i) a power flow, (ii) voltage fluctuations, or (iii) a power factor, for the region. In some implementations, the central controller layer monitoring conditions of the electric grid further includes obtaining geographical data related to the electric grid, wherein the geographical data includes weather conditions of the electric grid. In some implementations, the data related to the electric grid includes at least one of (i) market data, (ii) distribution management data, or (iii) energy management data.

In some implementations, the different regions of the electric grid include one or more different electrical feeders. In some implementations, the at least one grid edge device is an inverter and providing the one or more operational parameters to the inverter causes the inverter to operate autonomously within the one or more operational parameters. The grid edge devices can include one or more of: (i) an inverter, (ii) an energy storage device, (iii) an electric vehicle charging station, or (iv) a solar panel.

In some implementations, each of the hubs are configured to report electric grid data for the respective region of the hub, the electric grid data representing (historical/current) measurements of respective grid edge devices. In some implementations, the electric grid operation system performs operations including obtaining, by the central controller layer, the sensor data corresponding to the measurements performed by the grid edge devices. Obtaining the sensor data can include transmitting a request for the sensor data to at least one hub of the plurality of hubs and, in response to the request, receiving the sensor data from respective grid edge devices associated with the at least one hub.

In some implementations, determining, by the central controller layer, the individual control strategies for each different region of the electric grid includes performing data analytics using the sensor data and the expected grid-wide operations. Performing data analytics can further include determining at least one of (i) battery charging and discharging patterns, (ii) volt/var optimization, or (iii) power quality improvement. The expected grid-wide operations can include weather data related to geographic regions encompassed by the electric grid.

In some implementations, the central controller layer is configured to perform operations including updating a model based on the sensor data from each of the hubs, and determining, using the model, expected loads for each region in the electric grid during the period of time. The central controller layer can be configured to publish one or more of the individual control strategies to the intermediate controller layer, and the plurality of hubs are configured to subscribe to the intermediate controller layer to receive the respective one or more of the individual control strategies. In some implementations, the plurality of hubs can be configured to provide the one or more operational parameters to incrementally adjust operation of the least one grid edge device.

In an aspect, an electric grid operation method executed by one or more computers of an intermediate controller layer of a grid control architecture, the method includes communicating sensor data from one or more grid edge devices under supervision of the intermediate controller layer to a central controller layer of the grid control architecture, the sensor data representing grid operating conditions at the one or more grid edge devices, and the intermediate controller layer configured to monitor operations of grid edge devices within a region of an electric grid. The method also include receiving, from the central controller layer, a control strategy for the region of the electric grid, wherein the control strategy comprises expected electrical operating conditions for the region of the electric grid over a period of time. The method includes determining, based on the control strategy, one or more operational parameters for at least one grid edge device, wherein the one or more operational parameters provide constraints for autonomous operations of the at least one grid edge device during the time period based on the expected electrical operating conditions of the region of the electric grid. The method also include providing the one or more operational parameters to the least one grid edge device, wherein providing the one or more operational parameters causes the at least one grid edge device to adjust its operation.

In some implementations, the region includes an electrical feeder. In some implementations, the at least one grid edge device is an inverter and providing the one or more operational parameters to the inverter causes the inverter to operate autonomously within the one or more operational parameters. The expected electrical operating conditions of the control strategy for the region can include at least one of (i) a power flow, (ii) voltage fluctuations, or (iii) a power factor, for the region.

The details of one or more implementations of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a diagram of an example electric grid operation system for an electric grid.

FIGS. 2A and 2B are diagrams of example configurations of an electric grid operation system.

FIG. 3 is a swim lane diagram illustrating communications between the electric grid operation system and grid edge devices.

FIG. 4 is a flowchart illustrating an example process performed by an electric grid operation system.

FIG. 5 is a flowchart illustrating an example process performed by a hub of an electric grid operation system.

FIG. 6 is a schematic diagram of a computer system.

### DETAILED DESCRIPTION

This specification describes implementations to integrate operations of grid edge devices with higher level control layers for an electric power system. Systems and processes described may provide the advantage of efficient and reliable service on electric grids, using holistic control strategies for the grid edge devices. With improved operability, the grid edge devices of an electric grid can help mitigate the effects of failures in power distribution and transmission equipment, such as network protectors, transformers, feeders, and generators. Integration of the grid edge devices can more efficiently capture the benefits of renewable technologies, e.g., from inverters such as interfacing solar panels. In other words, inadequate operation of grid edge devices can lead to increased consumption and reliance on non-renewable technologies thereby increasing carbon emissions.

By accurately planning and controlling operation of the grid edge devices to proactively transition operations in response to anticipated changes in expected power flow, an electric grid is enabled to fully actualize the benefits of the grid edge device, thereby improving reliability and capacity. Additionally, conventional operation of grid edge devices has numerous inefficiencies derived from the de-centralization of the grid edge devices (e.g., each device may have a different interface). As part of the architecture, each hub of the intermediate controller layer can resolve differences in grid edge device interfaces and manage local operation of distribution systems over short time frames, while the central controller layer analyzes global data to determine overall operation strategies for each of the hubs over longer time periods. This architecture can provide seamless integration of the electric grid at every level by separating data and control planes.

For example, a central controller layer that monitors grid conditions and analyzes data sources enables the improved operability and efficiency of the grid edge devices. By integrating the grid edge devices into the operation of the electric grid, the central controller layer can provide high-level control strategies and analysis for the intermediate controller layer to adjust the operation of the grid edge devices. Holistic control strategies can incorporate transmission and distribution data from the entire electric grid, e.g., multiple feeder networks, to optimize power flow scheduling for a localized portion, e.g., a hub and its respective edge grid devices, of the electric grid to improve overall grid reliability. The control strategy provided to a hub in the intermediate controller layer includes estimations of the transmitted power flows that the hub can expect over a period of time (e.g., hours, days, weeks).

As an example, the control strategy can indicate an expected amount of power flow for the hub for the next 24-hour period. The hub can adjust ranges of operating parameters for respective grid edge devices, and provide the appropriate parameters to any of the grid edge devices in the region of the electric grid that the hub monitors. Based on the expected amount of power flow, the hub can determine desired operating parameters for the grid edge devices, for which the grid edge devices can use for autonomous operation coordinated across the region of the electric grid. As an example, the control strategy can indicate expected load usage for the hub and that the grid edge devices need to perform actions, e.g., increase generation from distributed energy resources, and conserve power expenditure. The hub can determine operating characteristics to achieve the action based on the control strategy, so that the grid edge devices may sustain coordinated and autonomously operate during the time period for which the control strategy was determined by the central controller layer.

The central controller layer can receive localized distribution data from a hub of the intermediate controller layer, for which the hub monitors a localized portion of the electric grid and the respective grid devices that are connected to the localized portion. For example, the hub of the intermediate controller may detect a fault event occurring in a respective portion of the electric grid and can provide data regarding operating conditions of the grid edge devices and the respective portion of the electric grid to the central controller layer. The hub can receive a control strategy from the central controller layer for the hub to process. The control strategy can include estimated power flow characteristics (e.g., a load shedding schedule) for the hub to follow, and the hub can determine instructions (e.g., control commands) to operate a class of grid edge devices (e.g., a battery asset, inverter, electric vehicle) within a range of constrained parameters to meet the control strategy determined by the central controller layer. Each of the hubs can adjust the local operation of each grid edge device, so that each grid edge device can operate within the range of constrained parameters. Furthermore, the hubs of the intermediate controller layer determine the appropriate instructions to adjust operations of the respective grid edge devices.

A hub of the intermediate controller layer can determine a range of operating parameters (e.g., voltage, power, frequency) for each grid edge device to autonomously operate within the range. The intermediate controller layer is in communication with the central controller layer and can include multiple hubs—each hub is connected to one or more grid edge devices and monitors a portion of the electric grid. As the central controller layer performs data analytics and grid monitoring of the entire electric grid (e.g., the data plane) the intermediate controller layer enables the hubs to determine operational parameters in response to the central controller layer identifying impacts of grid events to determine an optimal response or schedule for the grid edge devices. The intermediate controller layer is primarily responsible for determining and providing operational parameters (e.g., the control plane) for the grid edge devices to autonomously operate within, thereby reducing computational complexity for the central controller layer by handling local constraints and interfaces for the grid edge devices. Furthermore, the hubs of the intermediate controller layer enable the grid edge devices to operate autonomously to improve grid stability in the context of the entire electric grid, e.g., as opposed to performing simple protective actions in response to localized events.

The combination of the central controller layer and intermediate controller layer in an electric grid operation system (e.g., platform architecture) enable protocol-agnostic automation of the grid edge devices on the electric grid, as well as up-to-date data analytics and predictions of electric grid demands. The electric grid operation system also enables efficient, integrated, and autonomous control of the grid edge devices to optimize performance of the electric grid. The hierarchy provided by the electric grid operation system (e.g., the central controller layer 102 and intermediate controller layer 106) can provide coordinated operation among grid edge devices in multiple regions of the electric grid.

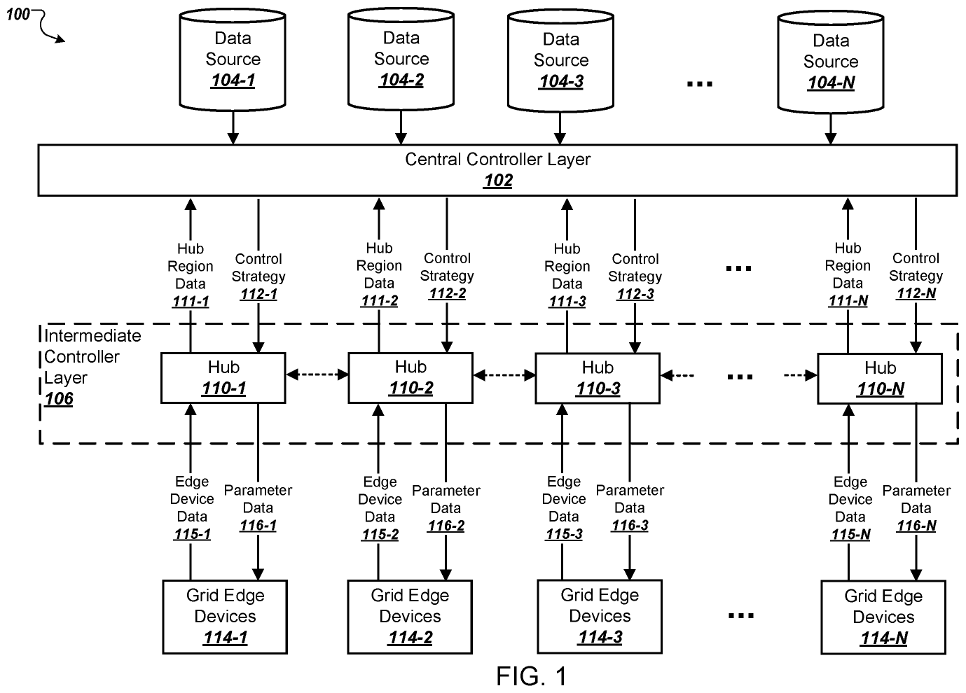

FIG. 1 is a diagram of an example electric grid operation system 100 for an electric grid. The electric grid can include grid edge devices 114-1-114-N (collectively referred to as “grid edge devices 114”). The grid edge devices 114 connected to the electric grid can be any type of device that connects to the grid edge, e.g., a point of electrical power delivery from the electric grid to devices such as inverters to draw power from the electric grid or generate power for the electric grid. The electric grid operation system 100 includes a central controller layer 102 that obtains data related to the electric grid from data sources 104-1-104-N (collectively referred to as “data sources 104”). The electric grid operation system 100 also includes an intermediate controller layer 106 that further includes a number of hubs 110-1-110-N (collectively referred to “hubs 110”). The central controller layer 102 is in communication with the intermediate controller layer 106 to obtain data related to the electric grid, e.g., from the hubs 110 monitoring different regions of the electric grid. The central controller layer 102 performs analytics (e.g., cloud computing) based on the data sources 104 and data related to the grid edge devices, e.g., by the hubs 110, to determine an appropriate control strategy 112-1-112-N (collectively referred to as “control strategies 112”) for the hubs 110 of the intermediate controller layer 106.

A control strategy 112-1-112-N for a respective hub that indicates expected electrical operating conditions for the region monitored by the respective hub. Each of the hubs 110 generate a respective set of parameter data 116-1-116-N (collectively referred to as “parameter data 116”) based on the respective control strategy 112-1-112-N for the respective grid edge devices, e.g., grid edge devices 114-1-114-N, of the hub. The grid edge devices 114-1-114-N can adjust operation of one or more grid edge devices based on the respective set of parameter data 116-1-116-N, e.g., adjusting consumption of electric power from the electric grid, adjusting generation of electrical power. The control strategies 112-1-112-N determined by the central controller layer 102 can provide that a respective hub (e.g., hub 110-1) can determine parameter data (e.g., parameter data 116-1) that enables autonomous operation of a respective set of grid edge devices (e.g., grid edge devices 114-1). The autonomous operation of the grid edge devices, based on the respective control strategy, can provide automated distribution of electric power that can respond to localized fluctuations within the operational ranges determined by the respective hub of the grid edge devices.

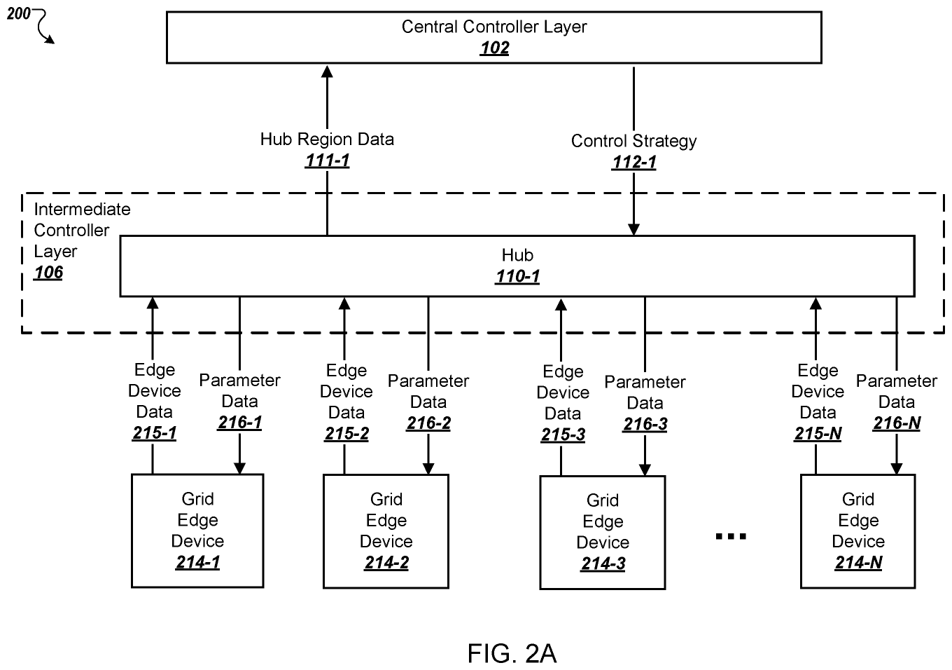

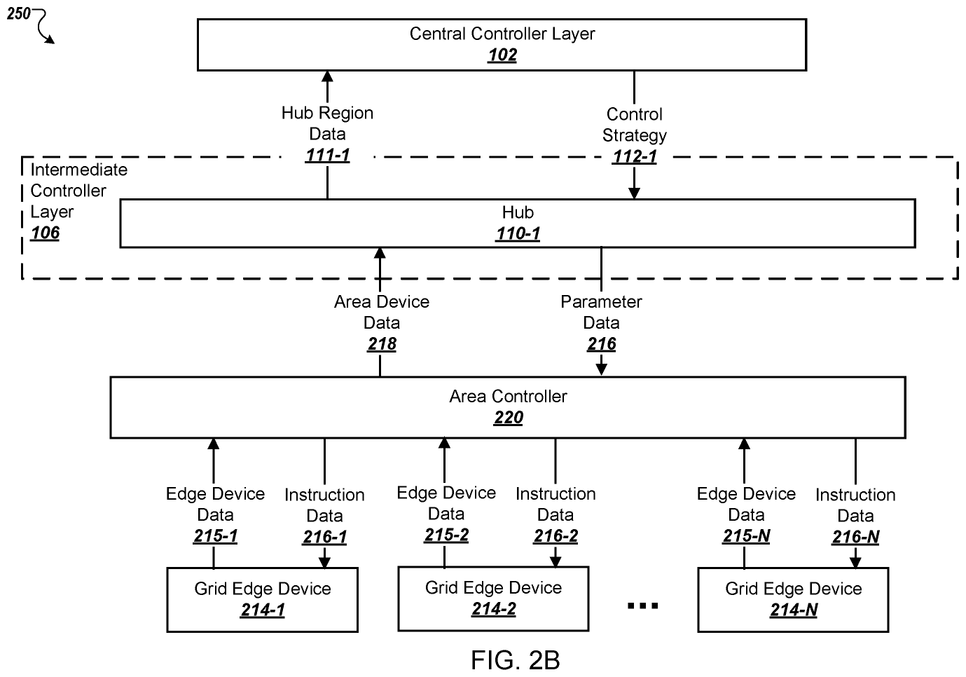

Each of the hubs 110 monitors a region of the electric grid that can include one or more different feeders that distribute electricity from a substation, e.g., configured to step down high voltage power from transmission lines, to the edge of the electric grid. Furthermore, the hubs 110 can be configured to communicate with each other, e.g., to aggregate data across multiple hubs and provide data for multiple regions of the electric grid. In some implementations, a hub can be configured to connect to an area controller, that is further configured to obtain sensor data from multiple grid edge devices and provide instruction data to operate the grid edge devices for the hub (as described in FIG. 2B below). Each of the grid edge devices 114-1-114-N can be connected to the grid edge, and provide a respective set of edge device data 115-1-115-N (e.g., sensor data) from measurements performed by grid edge devices 114 of a respective region of the electric grid. The grid edge devices 114 can include inverters in communication with devices such as photovoltaic panels (e.g., solar panels), electric vehicle charging stations, and battery assets. In some implementations, the grid edge devices 114 can generate power as a distributed energy resource (DER), e.g., to provide power for the electric grid at the grid edge.

A grid edge device in a set of grid edge devices (e.g., grid edge devices 114-1) associated with a respective hub (e.g., hub 110-1) can capture measurements (e.g., sensor data) at a location in the respective region indicating where the grid edge device is located (e.g., installed). The measurements captured by a grid edge device can include readings for an amount of energy generated or consumed by the grid edge device, e.g., in kilowatt-hours (kWh). In some implementations, the grid edge device can perform localized measurements for voltage, frequency, power flow, and other electrical characteristics of the grid edge at the location of the grid edge device. The grid edge device can send the localized measurements to its associated hub (e.g., hub 110-1). The sensor data from one or more grid edge devices, e.g., in grid edge devices 114-1-114-N, can be provided as part of the respective hub region data, e.g., hub region data 111-1-111-N, which can then be provided, requested, or obtained by the central controller layer 102 to perform data analytics. In some implementations, the central controller layer 102 can update a model of the electric grid based on the measurements (e.g., sensor data) from the hubs 110 to determine expected flow of power (e.g., loads) for the respective regions of the hubs 110 during a period of time, e.g., a couple of days or weeks.

The central controller layer 102 performs analytics using the data from data sources 104-1-104-N and data from each hub 110-1-110-N, e.g., hub region data 111-1-111-N, to generate control strategies 112. The data provided by a respective hub can include any of the hub region data 111-1-111-N for a respective region monitored by the hub. The central controller layer 102 can perform analytics data from the data sources 104-1-104-N and hub region data 111-1-111-N, to generate control strategies 112-1-112-N for each hub 110. As an example, the central controller layer 102 can perform an algorithm to determine battery charging and discharging patterns with optimized timing. The central controller layer 102 can provide a control strategy to a hub indicating that the hub can charge batteries in anticipation of a weather pattern that is expected to compromise electric grid stability, e.g., thereby maintaining the expected power flows for the region of the hub. As another example, the control strategy provided to the hub can indicate that the hub can discharge batteries to compensate for lower than expected flows during a time of reduced solar power output.

The central controller layer 102 can perform an algorithm to determine control strategies 112 to fulfill objectives in Volt-VAR (e.g., volt-ampere reactive power) optimization. For example, the control strategies 112 can provide expected power flows to the hubs 110 to regulate voltage and reactive power across different regions of the electric grid. Coordinated autonomous control of the grid edge devices provided by the central controller layer 102 (e.g., by the hubs 110) can regulate voltage at the grid edge of the electric grid across multiple regions of the electric grid, e.g., maintaining voltage of the grid edge in an acceptable range. Coordinated autonomous control of the grid edge devices can also provide regulated reactive power at the grid edge of the electric grid across multiple regions, e.g., maintaining a power factor close to 1 indicating a largely real power. Furthermore, the central controller layer 102 can determine control strategies 112 to achieve (e.g., maintain) load characteristics at different regions of the electric grid for conservation voltage reduction (e.g., energy efficiency of the electric grid), peak shaving (e.g., reducing peak electric grid capacity), and power quality correction (e.g., correcting voltages or canceling harmonics). For example, the central controller layer 102 can perform data analytics to determine control strategies 112 that improve the power quality, e.g., minimizing distortion affecting frequency and voltage profiles of power flows. Power quality improvement can also include improved balance between electrical waveform phases (e.g., of a three-phase system that supplies power), and compensation for harmonics of electrical devices on the electric grid. In some implementations, the control strategies 112 can achieve power quality improvement by adjusting power flow levels to compensate for distortion and achieve improved power factors, e.g., more apparent power provided by devices at the grid edge.

The central controller layer 102 can perform data analytics using data sources 104 that include operational data (e.g., load profiles, voltage profiles, and measured impedances) from the hub region data 111-1-111-N, as inputs for planning and modeling forecasted loads. The central controller layer 102 can integrate and manage the addition, upgrade, or removal of assets, e.g., any of the grid edge devices 114, when forecasting and planning power flows for the electric grid. In some implementations, the central controller layer 102 can be remotely accessed to view reports and pull data regarding the grid edge devices, e.g., through the hub region data 111-1-111-N. The data analytics performed by the central controller layer 102 can provide improved integration for transmission and distribution planning (e.g., for electric grid assets including transformers, network protectors, feeders, substations) as well as planning and operation of the electric grid, e.g., through the control strategies 112. In some implementations, the central controller layer 102 can incorporate data related to vegetation management (e.g., scheduled removal of unwanted vegetation in proximity to power lines and other electric equipment) when forecasting expected power loads and flows of the electric grid. In some implementations, the central controller layer 102 can perform analytics to improve power quality (e.g., voltage profile, frequency profile, electrical harmonics, and power factor) of the electric grid, e.g., by control strategies 112 provided to the intermediate controller layer 106 and hubs 110.

In some implementations, the control strategies 112 determined by the central controller layer 102 can provide self-healing capabilities to the electric grid. For example, the central controller layer 102 can identify faults in one or more regions of the electric grid and calculate estimated power loads for all of the regions of the electric grid, accounting for the faults and maintaining power load demands of the electric grid. In some implementations, the central controller layer 102 can perform reconfiguration of the electric grid to restore the electric grid in response to a detected fault. For example, the controller layer 102 can update control strategies for each hub to help stabilize or restore the grid in response to the fault. The hubs 110 then provide parameter data 116 to grid edge devices 114 to autonomously operate in a process to stabilize or restore the electric grid. Furthermore, the central controller layer 102 performs load shedding prioritization and load recovery prioritization, e.g., based on a class of service such as consumer or commercial or industrial customers. The control strategies 112 can provide expected power loads that incorporate load shedding or load recovery activities to the hubs 210, in which the grid edge devices 114 can be configured to autonomously operate within parameter data 116. In some implementations, the central controller layer 102 can analyze data sources 104 to perform predictive asset and outage management when forecasted expected loads for the hubs 110.

The central controller layer 102 can obtain data from data sources 104 such as data related to weather, electric market pricing, outages, planned maintenance, etc. forecasted for the electric grid. In some implementations, the central controller layer 102 can generate forecasts for power flows in the electric grid based on the pricing of electric power purchased in an energy market. For example, the central controller layer 102 can generate a control strategy for a hub indicating that the grid edge devices should be configured to store additional energy, in advance of the expected price of electric power increasing, e.g., due to increased demand, or lower supply. The central controller layer 102 can provide improved efficiency and reduce costs by forecasting and calculating energy costs during peak demand, and offset these costs by increasing DER generations at the grid edge through grid edge devices 114. Data sources 104 can also include data (e.g., power flows, faults, transformer loads) from distribution management systems that monitor and control electric power distribution throughout the electric grid, e.g., feeder lines and other connecting lines from substations to the grid edge. Data sources 104 can also include data (e.g., voltage ratings, voltage drop, frequency) from energy management systems that monitor or control generation of electric power, e.g., from power plants to substations of an electric grid.

In some implementations, the data from data sources 104 can include a forecast for the electric grid for an upcoming time window, e.g., a few days, a week. Weather data from data sources 104-1-104-N can indicate changes in weather patterns (e.g., heat waves, cold fronts) and precipitation (e.g., thunderstorms, snowstorms) that a geography of the electric grid is forecasted to expect. These changes in weather patterns can affect operation of grid edge devices, in which the central controller layer 102 can determine control strategies 112-1-112-N in response to analyzing the weather data and maintain sustainable operation of the electric grid. The central controller layer 102 can analyze the weather data to identify a weather pattern, e.g., a snowstorm, and prepare control strategies 112-1-112-N indicating an expected amount of power flow for a respective hub 110-1-110-N. In some implementations, the central controller layer 102 can analyze the weather pattern and determine that one or more of the hubs can fulfill electrical load demands of their respective monitored regions by conserving energy stored in grid edge devices for the one or more hubs.

The central controller layer 102 can provide control strategies to a first subset of the hubs 110 to indicate that some or all of the grid edge devices corresponding to the first subset of hubs can adjust operation to reduce consumption of stored electric power. By reducing consumption of stored electrical power, some or all of the grid edge devices autonomously operate within parameters to conserve energy, thereby becoming more reliant on the electric grid in the short term. The central controller layer 102 can provide control strategies to a second subset of the hubs 110 to indicate that some or all of the grid edge devices corresponding to the second subset of the hubs can adjust operation to increase consumption of stored electric power. By increasing consumption of stored electrical power, some or all of the grid edge devices autonomously operate within parameters to expend energy, thereby becoming less reliant on the electric grid in the short term. In some implementations, the central controller layer 102 can publish the control strategies 112 to the intermediate controller layer 106, in which each of the hubs 110-1-110-N subscribe to the intermediate controller layer 106 to receive the respective control strategy 112-1-112-N.

As the control strategies 112 and parameter data 116 include exchanges of data (e.g., sensor data, operational characteristics, measurements) between layers of the electric grid operation system, control of the grid edge devices 114 can be performed agnostically with respect to protocols and independently of the interfaces between layers. For example, the control strategies 112 and the sets of parameter 116 can indicate set points of voltage, active and reactive power.

In some implementations, the central controller layer 102 can publish the control strategies 112 to the intermediate controller layer 106, with a topic label indicating a type of event (e.g., fault, maintenance, weather pattern) associated with the control strategy. A hub can subscribe to the intermediate controller layer 106, to receive control strategies 112 with a particular topic label of an event occurring in the respective region of the hub. In other words, the topics of a control strategy can indicate a type of event (e.g., fault, weather, maintenance), in which all control strategies with the particular topic label can be provided to the hubs 110. In response to receiving the control strategies with the particular topic label, one or more of the hubs can generate parameter data for the respective grid edge devices 114-1-114-N.

FIG. 2A illustrates an example electric grid operation system 200. The central controller layer 102 is in communication with the intermediate controller layer 106. The intermediate control layer 106 obtains hub region data 111-1 from the hub 110-1 that monitors a region of the electric grid. The hub 110-1 is in communication with grid edge devices connected to the electric grid in the region. For example, the grid edge devices of the region monitored by hub 110-1 can include grid edge devices 214-1-214-N, that each provide a respective set of edge device data 215-1-215-N. The sets of edge device data 215-1-215-N can be aggregated by the hub 110-1 into hub region data 111-1, then provided to the central controller layer 102. In response to receiving the hub region data 111-1 from the hub 110-1, the central controller layer 102 can generate the control strategy 112-1 that includes an expected power flow determined. As discussed in reference to FIG. 1 above, the central controller layer determines the control strategy 112-1 using algorithms and data analytics, based on the hub region data 111-1 and data sources 104.

The central controller layer 102 can identify an event occurring in a region, e.g., corresponding to the hub 110-1. In some implementations, the identified event can occur in a neighboring region (e.g., corresponding to other hubs of the electric grid), as well as regions from neighboring electric grids in communication with the electrical grid operated by electric grid operation system 200. The events can include planned maintenance for electrical equipment, e.g., feeders and substations, anticipated storms occurring in the geography of the electric grid, and faults in the feeder lines.

As an example, the central controller layer 102 can detect a fault in a feeder line of a neighboring region of the region monitored by hub 110-1. Upon detecting the fault, the central controller layer 102 can request hub region data 111-1 (e.g., as well as multiple sets of hub region data 111-1-111-N) to determine operational characteristics of the region of the electric grid monitored by the hub 110-1. The operational characteristics can include localized power flow data, frequencies, voltages, electrical harmonics, and other measurements recorded or captured by the grid edge devices 214-1-214-N. Based on the operational characteristics aggregated by the hub 110-1, the central controller layer 102 can employ electric grid models to forecast short-term loads for the hub 110-1, accounting (e.g., compensating) for the detected fault.

For example, the central controller layer 102 can simulate operations of the electric grid on a model using the operational characteristics aggregated by the hub 110-1 as input to the simulation. In some implementations, the forecasted short-term loads for the hub 110-1 can include generating a control strategy 112-1 indicating that the hub 110-1 may receive less power from the electric grid, resulting in the grid edge devices 214-1-214-N ramping up electric power production at the grid edge to sustainably maintain electric grid operations. In some implementations, the control strategy 112-1 can indicate that the hub 110-1 may receive more electric power from the electric grid, resulting in the grid edge devices 214-1-214-N conserving (e.g., storing) power.

From the control strategy 112-1, the hub 110-1 can determine multiple sets of parameter data 216-1-216-N for the grid edge devices 214-1-214-N. A set of parameter data 216-1 for grid edge device 214-1 can include a number of target set points or operating parameters for the grid edge device 214-1 to maintain, e.g., by adjusting operations. The set points for the grid edge devices provide operational parameters for the grid edge device to autonomously operate based on the control strategy 112-1, thereby preparing the region corresponding to the hub 110-1 to fulfill power loads while maintenance is performed to resolve the fault. For example, during maintenance, a number of reclosers, inverters, and protective systems can be enabled to segment a region of the electric grid, so that the fault in a portion of the region can be resolved. Prior and during the maintenance repairs being performed, the grid edge devices 214-1-214-N can operate within the set points provided by parameter data 216-1-216-N to prepare and accommodate for the expected power flows of the control strategy 112-1. The grid edge devices 214-1-214-N can provide additional electrical power to compensate for a lower expected power flow (e.g., due to the fault) and thereby provide sustainable service to the electric grid.

In some implementations, the central controller layer 102 obtains the sensor data from a grid edge device (e.g., grid edge device 214-1) by transmitting a request to a respective hub (e.g., hub 110-1) associated with the grid edge device, e.g., monitored by the hub. In response to the request, the hub 110-1 can provide hub region data 111-1 that includes edge device data (e.g., edge device data 215-1) for the grid edge device. The hub 110-1 generates hub region data 111-1 that can include historical and current measurements of respective grid edge devices, e.g., grid edge devices 214-1-214-N. In some implementations, a hub 110-1 can provide parameter data 216-1-216-N to grid edge devices 214-1-214-N, in which the grid edge devices 214-1-214-N can incrementally adjust operation, e.g., to provide semi-autonomous or manual control of the grid edge devices.

FIG. 2B illustrates an example electric grid operation system 250 with the central controller layer 102, in communication with the intermediate controller layer 106. The intermediate controller 106 obtains hub region data 111-1 from the hub 110-1 that monitors a region of the electric grid, by an area controller 220 that connects to the grid edge devices of the region. The area controller 220 provides area device data 218, which can include multiple sets of edge device data 215-1-215-N from multiple connected grid edge devices 214-1-214-N. The central controller layer 102 can perform data analytics using data sources 104 and the hub region data 111-1 to determine a control strategy 112-1 for the hub 110-1. The hub 110-1 can provide parameter data 116 to the area controller 220, which then provides instruction data 216-1-216-N for the grid edge devices 214-1-214-N of the region of the electric grid.

The area controller 220 provides instruction data 216-1-216-N to the respective grid edge device 214-1-214-N to adjust operation of the respective grid edge device based on the control strategy 112-1, e.g., accounting for grid-wide events and operations. In some implementations, the area controller 220 can control operation of multiple grid edge devices 214-1-214-N by generating instruction data 216-1-216-N to adjust operation of the grid edge devices 214-1-214-N. In other words, the area controller 220 provides the control to the grid edge devices 214-1-214-N, compared to the implementation illustrated in FIG. 2A above where the grid edge devices 214-1-214-N are configured to operate autonomously and adjust operation based on parameter data.

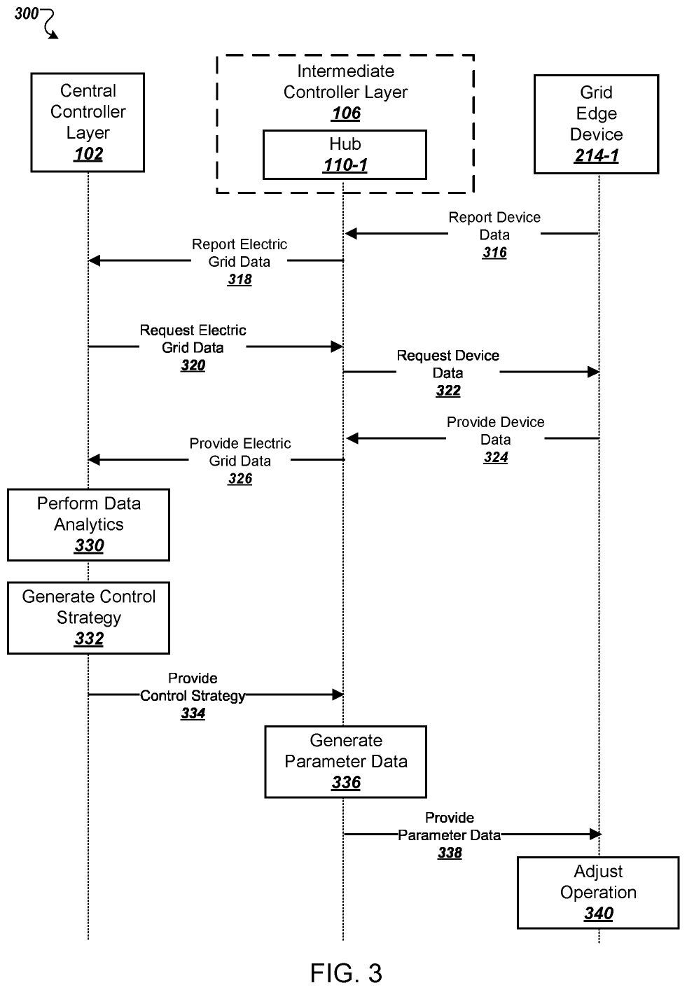

FIG. 3 is a swimlane diagram illustrating communications in an electric grid operation system 300 using the central controller layer 102 and the hub 110-1 from the intermediate controller layer 106 to enable coordinated autonomous control for grid edge device 214-1.

The grid edge device 214-1 can perform a push process, e.g., report device data 312 to the hub 110-1 of the intermediate controller layer 106. The grid edge device 214-1 provides measurements and other types of sensor data (e.g., localized voltages, frequency, power loads, outages) at the grid edge (e.g., of a region of the electrical grid) of the grid edge device 214-1 to the hub 110-1. The hub 110-1 can aggregate measurements and generate the reported device data 316 to the central controller layer 102, e.g., to report electric grid data 318, that can include historical/current measurements of the region of the electric grid monitored by hub 110-1. The reported electric grid data 318 can include operations performed in the region of the electric grid monitored by the hub 110-1, such as protective systems being triggered and faults occurring in a feeder line of the region.

The central controller layer 102 can perform a polling process, e.g., to request data from the grid edge device 214-1, by requesting electric grid data 320 from the hub 110-1. The request for electric grid data 320 includes obtaining data related to the operations of the region monitored by the hub 110-1. In some implementations, the request for electric grid data 320 can include a request for historical measurements (e.g., over a time period) as well as current measurements recorded by the grid edge device 214-1. The hub 110-1 performs a request to obtain the data from grid edge device 214-1, e.g., by requesting device data 322, in response to the request for electric grid data 320. The grid edge device 214-1 can fulfill the request for device data 322 by providing the historical/current measurements captured by the grid edge device 214-1 to the hub 110-1, which then aggregates the electric grid data (e.g., provide electric grid data 326 of the region monitored by the hub 110-1) to the central controller layer 106. The electric grid data 326 can include additional data from other grid edge devices of the region, but can also include a subset (e.g., data for a single grid edge device) of the grid edge devices.

The central controller layer 102 can perform data analytics 320, by analyzing data sources (e.g., data sources 104) and data related to one or more regions of the electric grid, e.g., the hub 110-1, other hubs of the electric grid. The central controller layer 102 can update a model using the data from the grid edge device and determine an expected load for the region corresponding to the hub 110-1. When performing data analytics 320, the central controller layer 102 can calculate forecasted power loads based on the sensor data of the grid edge devices 214-1 and the additional data provided by data sources 104, e.g., providing an estimate of load demands for the region for a period of time. Upon determining load demands for the region of the hub 110-1, the central controller layer generates control strategy 332 that indicates expected electrical operating conditions (e.g., voltages, frequencies, power factors, power flows) for the region monitored by the hub 110-1.

The central controller layer 102 then provides control strategy 332 to the hub 110-1, in which the hub 110-1 can generate parameter data 336 for the grid edge devices of the region. For the grid edge device 214-1, the hub 110-1 can provide parameter data 338 such that the grid edge device 214-1 can adjust operation 340, e.g., autonomously operating within one or more operational characteristics described in the parameter data 338. In some implementations, the grid edge device 214-1 can incrementally adjust operation based on the parameter data 338, e.g., interpolated electric operational characteristics determined by the hub 110-1 to perform smooth adjustments in grid edge device 214-1 operation.

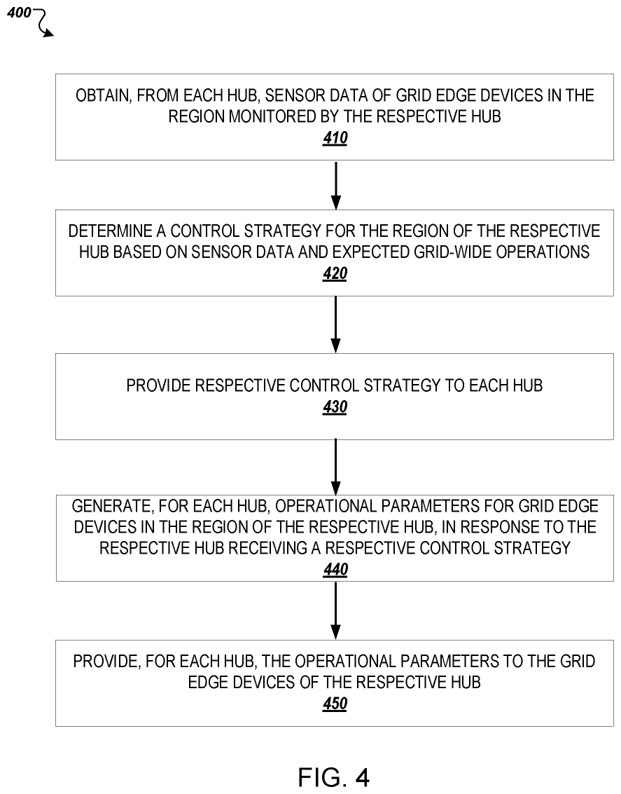

FIG. 4 is a flowchart illustrating an example process 400 for enabling autonomous and intelligent control of grid edge devices by an electric grid operation system. The electric grid operation system includes a central controller layer in communication with an intermediate controller layer that includes multiple hubs; each hub monitoring a region of the electric grid.

The central controller layer obtains, from each hub, sensor data of grid edge devices in the region monitored by the respective hub (410). As described in FIG. 3 above, in some implementations, the sensor data from the grid edge devices can be provided in response to a request for the sensor data from the central controller layer, e.g., by the hub of the grid edge device. The sensor data can include historical/current measurements of the grid edge devices, e.g., capturing localized electric characteristics of the grid edge. In some implementations, the sensor data from the grid edge devices can be reported to the hub, to be aggregated and provided as electric grid data by the hub to the central controller layer.

The central controller layer determines a control strategy for the region of the respective hub based on sensor data and expected grid-wide operations (420). The expected grid-wide operations can include geographical data representing weather patterns forecasted for the electric grid. Other types of data that the central controller layer can analyze include market data, electric distribution data, and electric transmission data. In some implementations, the central controller layer can determine the control strategy that includes forecasted electric power flows for each hub over a period of time. The central controller layer can leverage one or more models to generate estimations for load supply and demand of the electric grid, based on the data sources and sensor data. In some implementations, the central controller layer can include machine learning models to predict power flows based on training examples. These training examples can include historical actions in response to a grid-wide event determined by the central controller layer, such as expected flow for multiple regions of the electric grid.

The central controller layer provides a respective control strategy to each hub in the intermediate controller layer (430). The control strategy can include one or more estimates for power load over a time period for each hub. In some implementations, the central controller layer provides multiple control strategies for each hub, in which each control strategy can be labeled by a particular event type, e.g., planned maintenance, faults in feeder lines, weather patterns.

Each hub of the intermediate controller layer generates operational parameters for grid edge devices in the region of the respective hub, in response to the respective hub receiving a respective control strategy (440). The operational parameters can include set points for the grid edge device, e.g., localized power flows, frequencies, voltages.

Each hub of the intermediate controller layer provides the operational parameters to the grid edge devices of the respective hub (450). In response to receiving the operational parameters, the grid edge devices of the respective hub can adjust operation to autonomously operate, e.g., based on the set points for the grid edge device. In other words, the grid edge device performs intelligence operations to maintain electric grid reliability and performance, e.g., provided by a holistic analysis of the electric grid performed by the central controller layer.

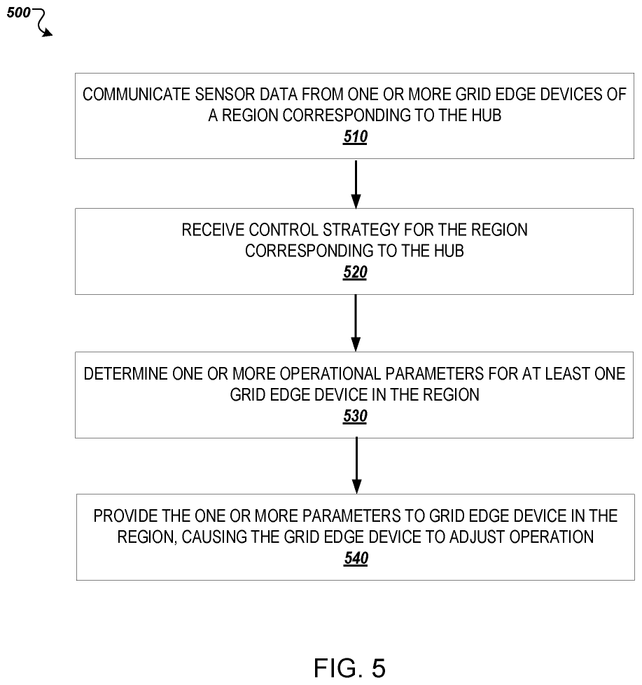

FIG. 5 is a flowchart illustrating an example process 500 performed by a hub of an electric grid operation system.

The hub communicates sensor data from one or more grid edge devices of a region corresponding to the hub (510). The hub can provide the sensor data in response to a request from the central controller layer, but can also report the data to the central controller layer to provide real-time status of the grid edge in the region monitored by the hub.

The hub receives a control strategy for the region corresponding to the hub (520). The control strategy can include expected electrical operating conditions for the region of the electric grid over a period of time. As described above in FIGS. 1-3, the control strategy can predict power flow, voltage fluctuations, power factors, and other electrical characteristics that the hub can expect from the electric grid over the period of time for the region.

The hub determines one or more operational parameters for at least one grid edge device in the region (530). Based on the received control strategy, the hub can determine a number of set points as inputs to one or more grid edge devices at the grid edge of the region. A grid edge device in the region can adjust its operation to meet the one or more operational parameters, e.g., autonomously adjusting its own control to operate according to the one or more operational parameters. The one or more operational parameters provide constraints for autonomous operation of a grid edge device during the time period based on the control strategy, e.g., expected electrical operation conditions of the region of the electric grid.

The hub provides one or more parameters to the grid edge device in the region, causing the grid edge device to adjust operation (540). By providing the one or more parameters to a grid edge device, the grid edge device can autonomously operate with intelligent control, e.g., performing operations to fulfill a holistic grid-wide strategy for the electric grid. The holistic strategy determined by the central controller layer provides that the grid edge devices can be leveraged as effective assets on the electric grid, providing sustainable and reliable electric power flows throughout the electric grid.

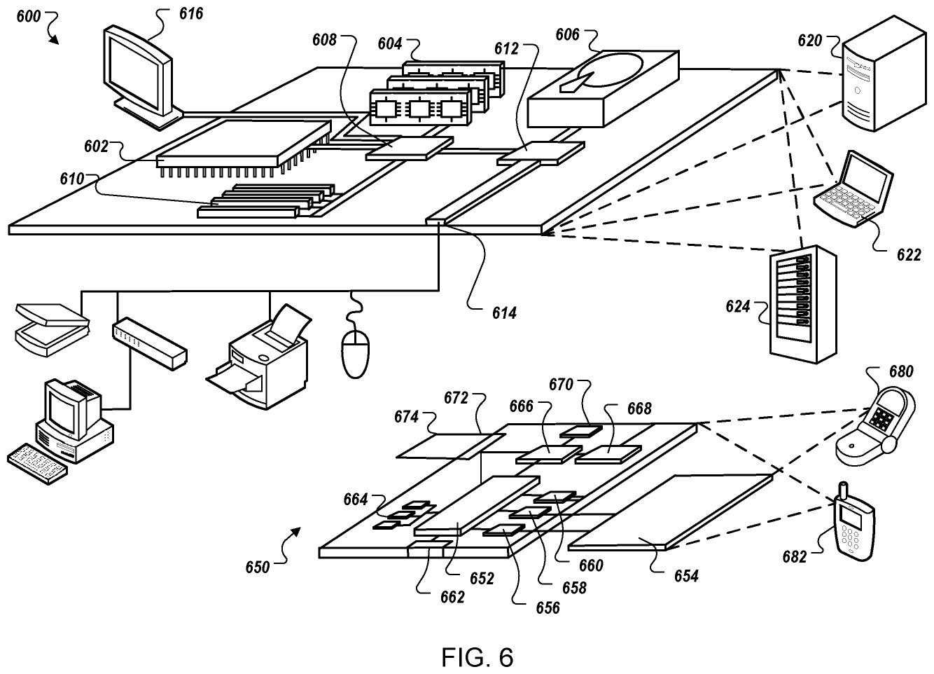

FIG. 6 is a diagram illustrating an example of a computing system used in an electric grid operation system. The computing system includes computing device 600 and a mobile computing device 650 that can be used to implement the techniques described herein. For example, one or more components of the electric grid operation system 100 could be an example of the computing device 600 or the mobile computing device 650.

The computing device 600 is intended to represent various forms of digital computers, such as laptops, desktops, workstations, personal digital assistants, servers, blade servers, mainframes, and other appropriate computers. The mobile computing device 650 is intended to represent various forms of mobile devices, such as personal digital assistants, cellular telephones, smart-phones, mobile embedded radio systems, radio diagnostic computing devices, and other similar computing devices. The components shown here, their connections and relationships, and their functions, are meant to be examples only and are not meant to be limiting.

The computing device 600 includes a processor 602, a memory 604, a storage device 606, a high-speed interface 608 connecting to the memory 604 and multiple high-speed expansion ports 610, and a low-speed interface 612 connecting to a low-speed expansion port 614 and the storage device 606. Each of the processor 602, the memory 604, the storage device 606, the high-speed interface 608, the high-speed expansion ports 610, and the low-speed interface 612, are interconnected using various buses, and may be mounted on a common motherboard or in other manners as appropriate. The processor 602 can process instructions for execution within the computing device 600, including instructions stored in the memory 604 or on the storage device 606 to display graphical information for a Graphical User Interface (GUI) on an external input/output device, such as a display 616 coupled to the high-speed interface 608. In other implementations, multiple processors and/or multiple buses may be used, as appropriate, along with multiple memories and types of memory. In addition, multiple computing devices may be connected, with each device providing portions of the operations (e.g., as a server bank, a group of blade servers, or a multi-processor system). In some implementations, the processor 602 is a single threaded processor. In some implementations, the processor 602 is a multi-threaded processor. In some implementations, the processor 602 is a quantum computer.

The memory 604 stores information within the computing device 600. In some implementations, the memory 604 is a volatile memory unit or units. In some implementations, the memory 604 is a non-volatile memory unit or units. The memory 604 may also be another form of computer-readable medium, such as a magnetic or optical disk.

The storage device 606 is capable of providing mass storage for the computing device 600. In some implementations, the storage device 606 may be or may include a computer-readable medium, such as a floppy disk device, a hard disk device, an optical disk device, or a tape device, a flash memory or other similar solid-state memory device, or an array of devices, including devices in a storage area network or other configurations. Instructions can be stored in an information carrier. The instructions, when executed by one or more processing devices (for example, processor 602), perform one or more methods, such as those described above. The instructions can also be stored by one or more storage devices such as computer- or machine-readable mediums (for example, the memory 604, the storage device 606, or memory on the processor 602). The high-speed interface 608 manages bandwidth-intensive operations for the computing device 600, while the low-speed interface 612 manages lower bandwidth-intensive operations. Such allocation of functions is an example only. In some implementations, the high speed interface 608 is coupled to the memory 604, the display 616 (e.g., through a graphics processor or accelerator), and to the high-speed expansion ports 610, which may accept various expansion cards (not shown). In the implementation, the low-speed interface 612 is coupled to the storage device 606 and the low-speed expansion port 614. The low-speed expansion port 614, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 600 may be implemented in a number of different forms, as shown in the figure. For example, it may be implemented as a standard server 620, or multiple times in a group of such servers. In addition, it may be implemented in a personal computer such as a laptop computer 622. It may also be implemented as part of a rack server system 624. Alternatively, components from the computing device 600 may be combined with other components in a mobile device, such as a mobile computing device 650. Each of such devices may include one or more of the computing device 600 and the mobile computing device 650, and an entire system may be made up of multiple computing devices communicating with each other.

The mobile computing device 650 includes a processor 652, a memory 664, an input/output device such as a display 654, a communication interface 666, and a transceiver 668, among other components. The mobile computing device 650 may also be provided with a storage device, such as a micro-drive or other device, to provide additional storage. Each of the processor 652, the memory 664, the display 654, the communication interface 666, and the transceiver 668, are interconnected using various buses, and several of the components may be mounted on a common motherboard or in other manners as appropriate.

The processor 652 can execute instructions within the mobile computing device 650, including instructions stored in the memory 664. The processor 652 may be implemented as a chipset of chips that include separate and multiple analog and digital processors. The processor 652 may provide, for example, for coordination of the other components of the mobile computing device 650, such as control of user interfaces, applications run by the mobile computing device 650, and wireless communication by the mobile computing device 650.

The processor 652 may communicate with a user through a control interface 658 and a display interface 656 coupled to the display 654. The display 654 may be, for example, a TFT (Thin-Film-Transistor Liquid Crystal Display) display or an OLED (Organic Light Emitting Diode) display, or other appropriate display technology. The display interface 656 may include appropriate circuitry for driving the display 654 to present graphical and other information to a user. The control interface 658 may receive commands from a user and convert them for submission to the processor 652. In addition, an external interface 662 may provide communication with the processor 652, so as to enable near area communication of the mobile computing device 650 with other devices. The external interface 662 may provide, for example, for wired communication in some implementations, or for wireless communication in other implementations, and multiple interfaces may also be used.

The memory 664 stores information within the mobile computing device 650. The memory 664 can be implemented as one or more of a computer-readable medium or media, a volatile memory unit or units, or a non-volatile memory unit or units. An expansion memory 674 may also be provided and connected to the mobile computing device 650 through an expansion interface 672, which may include, for example, a SIMM (Single In Line Memory Module) card interface. The expansion memory 674 may provide extra storage space for the mobile computing device 650, or may also store applications or other information for the mobile computing device 650. Specifically, the expansion memory 674 may include instructions to carry out or supplement the processes described above, and may include secure information also. Thus, for example, the expansion memory 674 may be provided as a security module for the mobile computing device 650, and may be programmed with instructions that permit secure use of the mobile computing device 650. In addition, secure applications may be provided via the SIMM cards, along with additional information, such as placing identifying information on the SIMM card in a non-hackable manner.

The memory may include, for example, flash memory and/or NVRAM memory (nonvolatile random access memory). In some implementations, instructions are stored in an information carrier such that the instructions, when executed by one or more processing devices (e.g., processor 652), perform one or more methods, such as those described above. The instructions can also be stored by one or more storage devices, such as one or more computer or machine-readable mediums (for example, the memory 664, the expansion memory 674, or memory on the processor 652). In some implementations, the instructions can be received in a propagated signal, for example, over the transceiver 668 or the external interface 662.

The mobile computing device 650 may communicate wirelessly through the communication interface 666, which may include digital signal processing circuitry in some cases. The communication interface 666 may provide for communications under various modes or protocols, such as GSM voice calls (Global System for Mobile communications), SMS (Short Message Service), EMS (Enhanced Messaging Service), or MMS messaging (Multimedia Messaging Service), CDMA (code division multiple access), TDMA (time division multiple access), PDC (Personal Digital Cellular), WCDMA (Wideband Code Division Multiple Access), CDMA2000, or GPRS (General Packet Radio Service), LTE, 3G/4G/5G cellular, among others. Such communication may occur, for example, through the transceiver 668 using a radio frequency. In addition, short-range communication may occur, such as using a Bluetooth, Wi-Fi, or other such transceiver (not shown). In addition, a GPS (Global Positioning System) receiver module 670 may provide additional navigation- and location-related wireless data to the mobile computing device 650, which may be used as appropriate by applications running on the mobile computing device 650.

The mobile computing device 650 may also communicate audibly using an audio codec 660, which may receive spoken information from a user and convert it to usable digital information. The audio codec 660 may likewise generate audible sound for a user, such as through a speaker, e.g., in a handset of the mobile computing device 650. Such sound may include sound from voice telephone calls, may include recorded sound (e.g., voice messages, music files, among others) and may also include sound generated by applications operating on the mobile computing device 650.

The mobile computing device 650 may be implemented in a number of different forms, as shown in the figure. For example, it may be implemented as a cellular telephone 680. It may also be implemented as part of a smart-phone 682, personal digital assistant, or other similar mobile device.

A number of implementations have been described. Nevertheless, it will be understood that various modifications may be made without departing from the spirit and scope of the disclosure. For example, various forms of the flows shown above may be used, with steps re-ordered, added, or removed.

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non-transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application-specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand-alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a data communication network.

In this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and be running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively in communication to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, i.e., inference, workloads. Machine learning models can be implemented and deployed using a machine learning framework, e.g., a TensorFlow framework, a Microsoft Cognitive Toolkit framework, an Apache Singa framework, or an Apache MXNet framework or similar.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface, a web browser, or an app through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. An electric grid operation system comprising:
a central controller layer configured to monitor conditions of an electric grid and control operations of the electric grid;
an intermediate controller layer in communication with the central controller layer, wherein the intermediate controller layer comprises a plurality of hubs configured to monitor operations of grid edge devices connected to different regions of the electric grid;
wherein the central controller layer is configured to perform operations comprising:
obtaining, from each hub, sensor data corresponding to measurements performed by the grid edge devices monitored by the hub;
determining, based on the sensor data and expected grid-wide operations, individual control strategies for each different region of the electric grid, wherein each control strategy comprises expected electrical operating conditions for the respective region of the electric grid over a period of time; and
providing a respective control strategy to each hub; and
wherein each hub of the plurality of hubs in the intermediate controller layer is configured to perform operations comprising:
in response to receiving the respective control strategy for the hub, generating one or more operational parameters for at least one grid edge device for the operation of the electric grid, wherein generating the one or more operational parameters is based on the expected amount of power flow for the hub; and
providing the one or more operational parameters to the least one grid edge device, wherein providing the one or more operational parameters causes the at least one grid edge device to adjust its operation.

2. The electric grid operation system of claim 1, wherein the expected electrical operating conditions of the control strategy for the region comprise at least one of (i) a power flow, (ii) voltage fluctuations, or (iii) a power factor, for the region.

3. The electric grid operation system of claim 1, wherein the central controller layer monitoring conditions of the electric grid further comprises obtaining geographical data related to the electric grid, wherein the geographical data includes weather conditions of the electric grid.

4. The electric grid operation system of claim 3, wherein the data related to the electric grid comprises at least one of (i) market data, (ii) distribution management data, or (iii) energy management data.

5. The electric grid operation system of claim 1, wherein the different regions of the electric grid comprise one or more different electrical feeders.

6. The electric grid operation system of claim 1, wherein the at least one grid edge device is an inverter and wherein providing the one or more operational parameters to the inverter causes the inverter to operate autonomously within the one or more operational parameters.

7. The electric grid operation system of claim 1, wherein the grid edge devices comprise one or more of: (i) an inverter, (ii) an energy storage device, (iii) an electric vehicle charging station, or (iv) a solar panel.

8. The electric grid operation system of claim 1, wherein each of the hubs are configured to report electric grid data for the respective region of the hub, the electric grid data representing (historical/current) measurements of respective grid edge devices.

9. The electric grid operation system of claim 1, wherein obtaining, by the central controller layer, the sensor data corresponding to the measurements performed by the grid edge devices comprises transmitting a request for the sensor data to at least one hub of the plurality of hubs and, in response to the request, receiving the sensor data from respective grid edge devices associated with the at least one hub.

10. The electric grid operation system of claim 1, wherein determining, by the central controller layer, the individual control strategies for each different region of the electric grid comprises performing data analytics using the sensor data and the expected grid-wide operations.

11. The electric grid operation system of claim 10, wherein performing data analytics further comprises determining at least one of (i) battery charging and discharging patterns, (ii) volt/var optimization, or (iii) power quality improvement.

12. The electric grid operation system of claim 10, wherein the expected grid-wide operations further comprises weather data related to geographic regions encompassed by the electric grid.

13. The electric grid operation system of claim 1, wherein the central controller layer is configured to perform operations comprising:
updating a model based on the sensor data from each of the hubs; and
determining, using the model, expected loads for each region in the electric grid during the period of time.

14. The electric grid operation system of claim 1, wherein the central controller layer is configured to publish one or more of the individual control strategies to the intermediate controller layer, and the plurality of hubs are configured to subscribe to the intermediate controller layer to receive the respective one or more of the individual control strategies.

15. The electric grid operation system of claim 1, wherein the plurality of hubs is configured to provide the one or more operational parameters to incrementally adjust operation of the at least one grid edge device.

16. An electric grid operation method executed by one or more computers of an intermediate controller layer of a grid control architecture, the method comprising:
communicating sensor data from one or more grid edge devices under supervision of the intermediate controller layer to a central controller layer of the grid control architecture, the sensor data representing grid operating conditions at the one or more grid edge devices, and the intermediate controller layer configured to monitor operations of grid edge devices within a region of an electric grid;
receiving, from the central controller layer, a control strategy for the region of the electric grid, wherein the control strategy comprises expected electrical operating conditions for the region of the electric grid over a period of time;
determining, based on the control strategy, one or more operational parameters for at least one grid edge device, wherein the one or more operational parameters provide constraints for autonomous operations of the at least one grid edge device during the time period based on the expected electrical operating conditions of the region of the electric grid; and
providing the one or more operational parameters to the least one grid edge device, wherein providing the one or more operational parameters causes the at least one grid edge device to adjust its operation.

17. The electric grid operation method of claim 16, wherein the region comprises an electrical feeder.

18. The electric grid operation method of claim 16, wherein the at least one grid edge device is an inverter and wherein providing the one or more operational parameters to the inverter causes the inverter to operate autonomously within the one or more operational parameters.

19. The electric grid operation method of claim 16, wherein the expected electrical operating conditions of the control strategy for the region comprise at least one of (i) a power flow, (ii) voltage fluctuations, or (iii) a power factor, for the region.

20. The electric grid operation method of claim 16, wherein the grid edge devices comprise one or more of: (i) an inverter, (ii) an energy storage device, (iii) an electric vehicle charging station, or (iv) a solar panel.
